(19) United States
(12) Patent Application Publication
(10) Pub. No.: US 2026/0029735 A1
(43) Pub. Date: Jan. 29, 2026

(54) IMAGE FORMING APPARATUS

(71) Applicant: CANON KABUSHIKI KAISHA, Tokyo (JP)

(72) Inventors: YOUSUKE KOZIMA, Ibaraki (JP); NAOKA OMURA, Chiba (JP); NAOKO MIMA, Ibaraki (JP)

(21) Appl. No.: 19/260,735

(22) Filed: Jul. 7, 2025

(30) Foreign Application Priority Data
Jul. 25, 2024 (JP) 2024-120346

(51) Int. Cl. G03G 15/20

(52) U.S. Cl. CPC G03G 15/205; G03G 15/2064; G03G 2215/00742; G03G 2215/00776; G03G 2215/2038

(57) ABSTRACT

When a first mode that a recording material conveying speed is a first speed is inputted to an input portion when a controller executes a continuous image forming job in which first recording materials each having the first basis weight and second recording materials each having the second basis weight are present in mixture, in a case where the continuous image forming job is such that the first recording materials are not continuous in a first number of sheets or more and that the second recording materials are continuous in a second number of sheets or more after the first recording material, the controller executes the continuous image forming job in a setting such that the recording material conveying speed is the first speed and a fixing temperature is a second temperature, for the second basis weight, lower than a first temperature for the first basis weight.

### BACKGROUND

### Field of the Technology

The present disclosure relates to an image forming apparatus such as a copying machine, a printer, a facsimile machine, or a multi-function machine having a plurality of functions of these machines.

### Description of the Related Art

The image forming apparatus includes a fixing device for fixing a toner image on a recording material by applying heat and pressure to the recording material while nipping and conveying the recording material on which the toner image is formed. The fixing device includes a rotatable heating member for heating the recording material and a rotatable pressing member for pressing the rotatable heating member in order to form a fixing nip in which the heat and the pressure are applied to the recording material while nipping and conveying the recording material. A heat quantity needed for fixing of the toner image is different depending on a basis weight of the recording material, so that in the fixing device, a speed when the recording material is nipped and conveyed (hereinafter, this speed is referred to as a conveying speed) and a set temperature of the rotatable heating member (hereinafter, this temperature is referred to as a fixing temperature) are adjustable.

However, there is a case where a printing operation of the image forming apparatus is temporarily stopped when the conveying speed and/or the fixing temperature is switched, so that by performing temporarily stop, productivity of the recording material lowers. In Japanese Laid-Open Patent Application No. 2005-321478, in the case where a continuous image forming job toner images are continuously formed on a plurality of recording materials in which recording materials different in fixing temperature are present in mixture (hereinafter, this job is referred to as a mixed job) is executed, it is proposed that a number of times of the temporarily stop is decreased by using a fixing temperature common to the plurality of recording materials before the mixed job is started, and thus a lowering in productivity of the recording material is suppressed.

### SUMMARY

According to an aspect of the present disclosure, there is provided an image forming apparatus comprising: an image forming unit configured to form a toner image on a recording material; a fixing unit including a first rotatable member, a second rotatable member configured to form a fixing nip, in contact with the first rotatable member, in which the recording material is nipped and conveyed therebetween, a driving portion configured to rotate at least either one of the first rotatable member and the second rotatable member, and a heating portion configured to heat the first rotatable member, the fixing unit being configured to fix the toner image on the recording material under application of heat and pressure to the recording material on which the toner image is formed; an input portion capable of inputting either one of operation modes including a first mode in which a conveying speed at which the recording material is conveyed in the fixing nip is a first speed and a second mode in which the conveying speed is a second speed slower than the first speed; a temperature setting portion capable of setting a fixing temperature, which is a set temperature of the first rotatable member, to a first temperature in a case where a basis weight of the recording material is a first basis weight, and capable of setting the fixing temperature to a second temperature lower than the first temperature in a case where the basis weight is a second basis weight smaller than the first basis weight; an acquiring portion capable of acquiring information on basis weights of a plurality of recording materials; and a controller capable of controlling the heating portion and the driving portion on the basis of the information on the basis weights acquired by the acquiring portion, wherein when the first mode is inputted to the input portion when the controller executes a continuous image forming job in which first recording materials each having the first basis weight and second recording materials each having the second basis weight are present in mixture, in a case where the continuous image forming job is a job in which the first recording materials are not continuous in a first number of sheets or more and in which the second recording materials are continuous in a second number of sheets or more after the first recording material, the controller executes the continuous image forming job in a setting such that the conveying speed is the first speed and the fixing temperature is the second temperature.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic view showing an image processing system.

FIG. 2 is a block diagram show a system constitution.

FIG. 3 is a schematic view showing an image forming apparatus according to an embodiment.

FIG. 4 is a schematic view showing a fixing device.

Parts (a), (b), and (c) of FIG. 5 are temperature tables each showing fixing temperature portion basis weights of recording materials, in which (a) shows a high-speed balance temperature-control mode, (b) shows a low-speed balance temperature-control mode, and (c) shows an image quality priority temperature control mode.

Parts (a), (b), and (c) of FIG. 6 are schematic views each showing a screen, in which (a) shows an initial screen, (b) shows an application mode selection screen, and (c) shows a speed/image quality priority adjustment setting screen.

FIG. 7 is a flowchart showing a part of a job start processing.

FIG. 8 is a flowchart showing a part of the job start processing.

FIG. 9 is a flowchart showing a part of the job start processing.

FIG. 10 is a flowchart showing a part of the job start processing.

Part (a) of FIG. 11 is a schematic view for illustrating processes S110, S111, S113, and S114 of the job start processing, part (b) of FIG. 11 is a schematic view for illustrating a conventional example, and part (c) of FIG. 11 is a schematic view for illustrating processes S110, S111, S113, and S112 of the job start processing.

Part (a) of FIG. 12 is a schematic view for illustrating processes S110, S115, S117, S118, and S119 of the job start processing, and part (b) of FIG. 12 is a schematic view for illustrating processes S110, S115, S117, and S112.

FIG. 13 is a flowchart showing a part of temporary stop processing.

FIG. 14 is a flowchart showing a part of the temporary stop processing.

FIG. 15 is a flowchart showing a part of the temporary stop processing.

### DESCRIPTION OF THE EMBODIMENTS

### First Embodiment

### <Image Forming System>

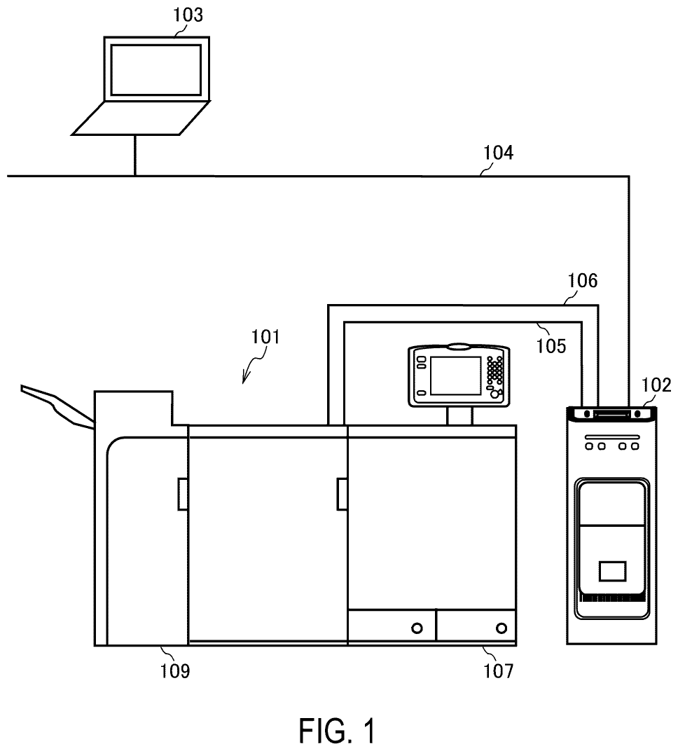

FIG. 1 is a schematic constitution view of an image processing system including an image forming apparatus 101 of an embodiment 1. The image process system includes the image forming apparatus 101 and an external controller 102. The image forming apparatus 101 is, for example, a multi-function machine, a multi-function peripheral (MFP), and the like.

The external controller 102 is, for example, an image processing controller, a digital front end (DFE), a print server, and the like.

The image forming apparatus 101 and the external controller 102 are communicatably connected to each other through an interval LAN (Local Area Network) 105 and a video cable 106. The external controller 102 is connected to a client PC (Personal Computer) 103 through an external LAN 104. The external controller 102 acquires an image forming job from the client PC 103.

In the client PC 103, a printer driver having a function of converting image data into print description language processable by the external controller 102 is installed. A user is capable of instructing printing through the printer driven by various applications.

The printer driver sends image data to the external controller 102 on the basis of the image forming job from the user. The external controller 102 receives the image forming job including the image data from the client PC 103 and performs data analysis and rasterization processing, so that the external controller 102 instructs printing (image formation) to the image forming apparatus 101 on the basis of the image data.

The image forming apparatus 101 is constituted by connecting thereto a plurality of apparatus including a printing device (apparatus) 107 and having different functions, and is capable of performing complicated printing processing such as book-binding and the like. The image forming apparatus 101 in this embodiment includes the printing device 107 and a finisher 109. The printing device 107 forms, with a developer (for example, toner), an image on a recording material fed from a feeding portion provided in a lower portion of a main assembly of the image forming apparatus 101. The printing device 107 forms images of yellow (Y), magenta (M), cyan (C), and black (K). On the recording material, a full-color image obtained by superposing the respective color images. The recording material on which the image is formed is conveyed from the printing device 107 to the finisher 109. The finisher 109 stacks the recording material on which the image is formed.

This image processing system has a constitution in which the external controller 102 is connected to the image forming apparatus 101, but the external controller 102 is not necessarily required. For example, a constitution in which the image forming apparatus 101 directly acquires the image forming job including the image data from the client PC 103 through the external LAN 104 may be employed. In this case, the image forming apparatus 101 performs the data analysis and the rasterization processing which are performed by the external controller 102. That is, the image forming apparatus 101 and the external controller 102 may be constituted integrally with each other.

### <System Constitution>

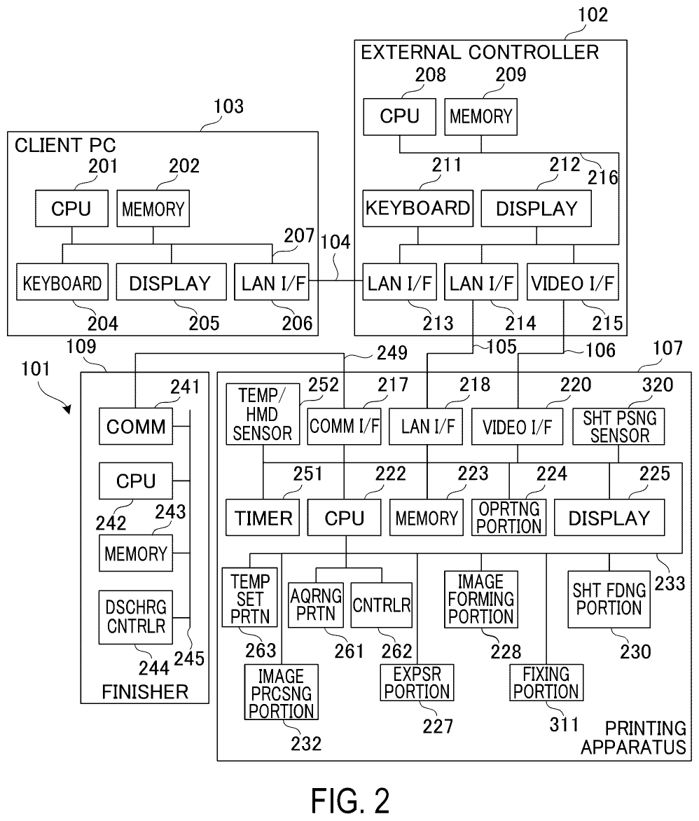

FIG. 2 is a block diagram of a system constitution for controlling an operation of the image processing system. In this embodiment, for each of the image forming apparatus 101, the external controller 102, and the client PC 103, a controller for controlling the operation will be described.

### <Printing Device>

The printing device 107 includes a communication interface (I/F) 217, an LAN I/F218, and a video I/F220 in order to communicate with other devices. The printing device 107 includes a CPU (Central Processing Unit) 222, a memory 223, and an image processing portion 232 in order to control the operation of the printing device 107. The printing device 107 includes an exposure portion 227, an image forming portion 228, a fixing device 311, and a sheet feeding portion 230 in order to form the image. The printing device 107 includes an operating portion 224 and a display 225 which are as user interfaces. The printing device 107 includes a timer 251 and a temperature/humidity sensor 252 for adjusting a correction value in order to optimally correct geometrical characteristics of images to be formed on a front surface and a back surface of the recording material. Here, the geometrical characteristics refer to, for example, perpendicularity, an image printing position on the recording material, and the like. The above-described constituent component parts are communicatably connected with each other through a system bus 233.

The communication I/F217 is connected to the finisher 109 through a communication cable 249 and controls communication between itself and the finisher 109. In the case where the printing device 107 and the finisher 109 cooperate therebetween, information and data are transmitted and received through the communication I/F217. The LAN I/F218 is connected to the external controller 102 through the internal LAN 105 and controls communication between itself and the external controller 102. The printing device 107 receives a print setting from the external controller 102 through the LAN I/F218. The video I/F220 is connected to the external controller 102 through the video cable 106 and controls communication between itself and the external controller 102. The printing device 107 receives image data, representing an image to be formed, from the external controller 102 through the video I/F220.

The CPU 222 as a controller comprehensively performs image processing and printing by executing a computer program stored in the memory 223. The memory 223 provides a work area when the CPU 222 executes various processing. In the case where the image forming processing is performed, the CPU 222 is capable of controlling the exposure portion 227, the image forming portion 228, the fixing device 311, and the sheet feeding portion 230.

The exposure portion 227 includes a photosensitive member, a charging wire for electrically charging the photosensitive member, and a light source for exposing, to light, the photosensitive member charged by the charging wire for forming an electrostatic latent image on the photosensitive member. Incidentally, the photosensitive member is, for example, a photosensitive belt in which a photosensitive layer is formed on a surface of a belt-like elastic member or a photosensitive drum in which the photosensitive layer is formed on a surface of a cylinder. Further, instead of the charging wire, a charging roller may be used. The exposure portion 227 charges a surface of the photosensitive member to a uniform negative potential by the charging wire. The exposure portion 227 causes the light source to output laser light based on the image data. The uniformly charged surface of the photosensitive member is scanned with the laser light. By this, the photosensitive member changes in potential at a position where the photosensitive member is exposed to the laser light, so that the electrostatic latent image is formed on the surface of the photosensitive member. Four photosensitive members are provided corresponding to four colors of yellow (Y), magenta (M), cyan (C), and black (K). On the four photosensitive members, electrostatic latent images corresponding to images different in color are formed.

The image forming portion 228 as an image forming unit transfers a toner image, formed on the photosensitive member, onto the recording material. The image forming portion 228 includes a developing device, a transfer unit, and a toner supplying portion. The developing device forms the toner image by depositing negatively charged toner on the surface of the photosensitive member from a developing cylinder. Four developing devices are provided correspondingly to the four colors of yellow (Y), magenta (M), cyan (C), and black (K). Each developing device develops the electrostatic latent image into a visible image on the photosensitive member for an associated color.

The transfer unit includes an intermediary transfer belt 308, and the toner image is transferred from the photosensitive member onto the intermediary transfer belt 308. In a position opposing the photosensitive members through the intermediary transfer belt 308, primary transfer rollers are provided respectively. By applying a position potential is applied to the primary transfer rollers, so that the toner image is transferred from each of the four photosensitive members onto the intermediary transfer belt superposedly. By this, a full-color toner image is formed on the intermediary transfer belt. The toner image formed on the intermediary transfer belt is transferred onto the photosensitive member by a secondary transfer roller described later. By applying the positive potential to the secondary transfer belt, the full-color toner images is transferred from the intermediary transfer belt 308 onto the recording material.

The fixing device 311 as a fixing unit fixes the transferred toner image on the recording material. The fixing device 311 includes a heater and a roller pair. The fixing device 311 melts and sticks the toner image on the recording material under application of heat and pressure by the heater and the roller pair. By this, a product such that the image is formed on the recording material is formed. The sheet feeding portion 230 includes conveying rollers and various sensors in a conveying path and controls a recording material feeding operation.

The operating portion 224 as an input portion is an input device receiving input of various settings and an operation instruction from a user, and is, for example, various input keys or a touch panel. The display 225 is an output device for displaying setting information of the image forming apparatus 101 and a processing status (status information) of the image forming job. In this embodiment, the operating portion 224 is capable of inputting, for example, a mixed job and an operation mode which is either one of a first mode in which a conveying speed at which the recording material is conveyed is a first speed and a second mode in which the conveying speed is a second speed slower than the first speed. The mixed job is a continuous image forming job for forming images onto a plurality of sheets of recording materials different in basis weight, and is a job in which a first recording material having a first basis weight and a second recording material having a second basis weight are present in mixture.

The timer 251 counts a time. The CPU 222 acquires present date and time by a count value of the timer 251. The temperature/humidity sensor 252 as a detecting portion detects an in-apparatus temperature and an in-apparatus humidity in the image forming apparatus 101 (specifically, in the printing device 107). The CPU 222 acquires, as an environmental condition, the in-apparatus temperature and the in-apparatus humidity by a detection result of the temperature/humidity sensor 252. A temperature setting portion 263 makes a setting of the fixing temperature depending on the basis weight of the recording material. The CPU 222 is capable of changing a temperature of a fixing belt 401 of the fixing device 311 on the basis of the fixing temperature set by the temperature setting portion 263.

### <Finisher>

The finisher 109 executes, for example, stapling (processing) of the product outputted from the printing device 107. The finisher 109 includes a communication I/F 241, a CPU 242, a memory 243, and a discharge controller 244. These constituent component parts are communicatably connected with each other through a system bus 245. The communication I/F 241 is connected to the printing device 107 through a communication cable 249 and controls communication between itself and the printing device 107. In the case where the finisher 109 and the printing device 107 cooperate, information and data re transmitted and received through the communication I/F 241. The CPU 242 executes a control program stored in the memory 243 and performs various pieces of control needed for sheet discharge. The memory 243 stores the control program. In addition, the memory 243 provides a work area in which the CPU 242 executes various processing. The discharge controller 244 discharges the conveyed recording material on the basis of an instruction from the CPU 242.

### <External Controller>

The external controller 102 includes an LAN I/F213, an LAN I/F214, and a video I/F215 in order to communicate with other devices. The external controller 102 includes a CPU 208 and a memory 209 in order to control an operation thereof. The external controller 102 includes, as user interfaces, a keyboard 211 and a display 212. These constitution component parts are communicatable connected with each other through a system bus 216.

The LAN I/F213 is connected to the client PC 103 through the external LAN 104 and controls communication between itself and the client PC 103. The external controller 102 acquires the image forming job from the client PC 103 through the LAN I/F213. The LAN I/F214 is connected to the printing device 107 through the internal LAN 105 and controls communication between itself and the printing device 107. The external controller 102 sends a printing setting to the printing device 107 through the LAN I/F214. The video I/F215 is connected to the printing device 107 through the video cable 106 and controls communication between itself and the printing device 107. The external controller 102 sends the image data to the printing device 107 through the video I/F215.

The CPU 208 comprehensively performs processing, such as image data reception sent from the client PC 103, RIP processing, and transmission of the image data to the image forming apparatus 101 by executing the computer program stored in the memory 209. The memory 209 provides a work area when the CPU 208 executes various processing. The keyboard 211 is an input device for receiving input of various settings and operation instruction from the user. The display 212 is an output device for displaying information of an execution application of the external controller 102 by a still image or a moving image.

### <Client PC>

The client PC 103 includes a CPU 201, a memory 202, a memory 202, a keyboard 204, a display 205, and an LAN I/F206. These constituent component parts are communicatably connected with each other through a system bus 207.

The CPU 201 controls an operation of the client PC 103 by executing a computer program stored in the memory 202. In this embodiment, the CPU 201 performs preparation of the image data and transmission processing of the image forming job. The memory 202 provides a work area when the CPU 201 executes various processing. The keyboard 204 and the display 205 are user interfaces. The keyboard 204 is an input device for receiving an instruction by the user. The display 205 is an output device for outputting information of an execution application of the client PC 103 by a still image or a moving image. The LAN I/F 206 is connected to the external controller 102 through the external LAN 104 and controls communication between itself and the external controller 102. The client PC 103 sends the image forming job including the image data through the LAN I/F206.

Incidentally, the external controller 102 and the image forming apparatus 101 are connected by the internal LAN 105 and the video cable 106, but may only be required to have a constitution in which transmission and reception of data needed for printing can be performed, so that these devices may be connected only by the video cable 106, for example. Each of the memory 202, the memory 209, the memory 223, and the memory 243 may only be required to be a storage device for holding the data and the program. As each of these memories, for example, a volatile RAM (Random Access Memory), a non-volatile ROM (Read Only Memory), a storage, a USB (Universal Serial Bus) memory, or the like can be used.

### <Constitution of Image Forming Apparatus>

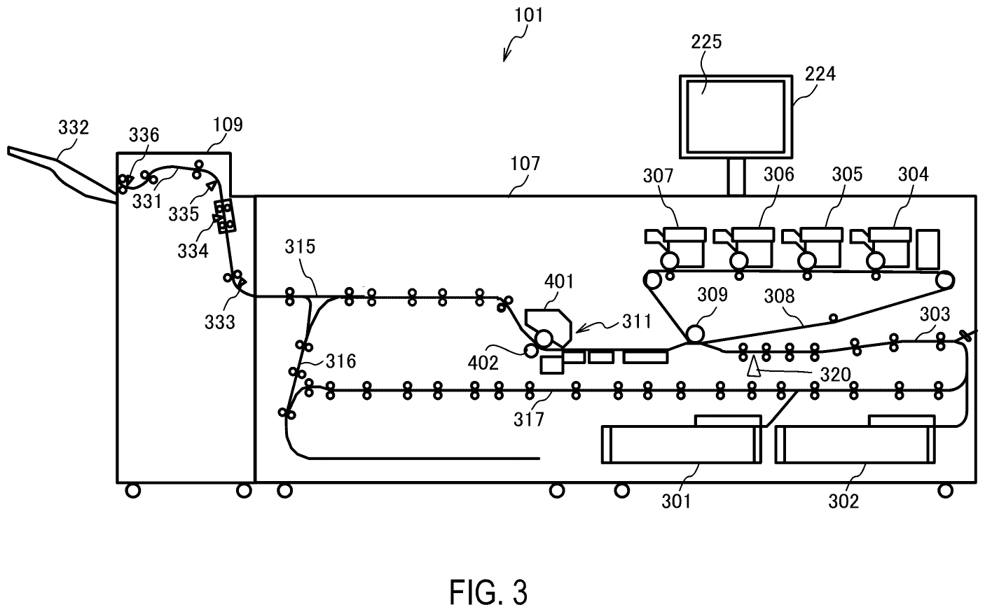

FIG. 3 is a schematic view showing a constitution of the image forming apparatus 101. In an upper portion of the printing device 107, the operating portion 224 including the display 225 is provided. The display 225 displays a printing status of the image forming apparatus 101 and information for a setting of the image forming apparatus 101. The recording material (product) on which the image is formed in the printing device 107 is conveyed to the finisher 109 provided in a post-stage.

The printing device 107 includes, as the sheet feeding portion 230, sheet feeding decks 301 and 302, and a conveying path 303. Each of the sheet feeding decks 301 and 302 is capable of accommodating recording materials different in kind. Information (basis weight, recording material kind, or the like) of the accommodated recording materials) is detectable on an apparatus side, and in this embodiment, a constitution in which the information is settable from the operating portion 224 by the user.

Of the recording materials accommodated in each of the sheet feeding decks 301 and 302, an uppermost (one) sheet is separated and is fed to the conveying path 303. The printing device 107 includes, as the exposure portion 227, image forming portions 304, 305, 306, and 307 in order to form images. The printing device 107 form a color image. For that purpose, the image forming portion 304 forms the image (toner image) of black (K). The image forming portion 305 forms the image (toner image) of cyan (C). The image forming portion 306 forms the image (toner image) of magenta (M). The image forming portion 307 forms the image (toner image) of yellow (Y).

The printing device 107 includes, as the image forming portion 228, the intermediary transfer belt 308 onto which the toner images are transferred from the image forming portions 304, 305, 306, and 307, respectively, and the secondary transfer roller 309.

The intermediary transfer belt 308 is rotated clockwise in FIG. 3, so that the toner images are superposedly transferred in an order of the image forming portion 307, the image forming portion 306, the image forming portion 305, and the image forming portion 304. By this, the full-color toner image is formed on the intermediary transfer belt 308. The intermediary transfer belt 308 conveys the toner image to the secondary transfer roller 309 by rotation thereof. In synchronism with a timing when the toner image is conveyed to the secondary transfer roller 309, the recording material is conveyed to the secondary transfer roller 309. The secondary transfer roller 309 transfers the toner image, transferred on the intermediary transfer belt 308, onto the conveyed recording material. Incidentally, with respect to a recording material conveying direction, on a side upstream of the secondary transfer roller 309, a recording material detecting sensor 320 for detecting passing of the recording material is provided.

The printing device 107 includes the fixing device 311. The fixing device 311 includes the fixing belt 401 and a pressing roller 402 in order to fix the toner image on the recording material. The recording material passes through a fixing nip formed by the fixing belt 401 and the pressing roller 402, so that heat and pressure are applied to the recording material. Thus, the toner image is melted and press-contacted to a first surface of the recording material.

The recording material passed through the fixing device 311 is guided to a conveying path 315. In the case where double-sided printing is instructed, the image is also formed on a back surface (second surface). For that reason, the recording material is guided to a reversing path 316. The recording material conveyed to the reversing path 316 is reversed in conveying direction in the reversing path 316, and is conveyed to a double-sided conveying path 317. By the reversing path 316 and the double-sided conveying path 317, the recording material is turned upside down by switch-back conveyance. The recording material is conveyed to the conveying path 303 by the double-sided conveying path 317 and passes through the secondary transfer roller 309 and the fixing device 311, so that the image is formed on the second surface different from the first surface.

In the case of one-sided printing or in the case where the images are formed on the both surfaces of the double-sided printing, the recording material is conveyed to the conveying path 315 and is delivered to the finisher 109.

The finisher 109 is capable of stacking the recording material delivered from the printing device 107. The finisher 109 includes a conveying path 331 and a stacking tray 332 for stacking the recording material. The conveying path 331 is provided with conveyance sensors 333, 334, 335, and 336. The recording material conveyed from the printing device 107 passes through the conveying path 331 and is stacked on the stacking tray 332. Each of the conveyance sensors 333, 334, 335, and 336 detects passing of the recording material conveyed through the conveying path 331. In the case where a leading and or a trailing end of the recording material with respect to the recording material conveying direction is not detected by the conveyance sensors 333, 334, 335, and 336 even when a predetermined time has elapsed from a start of the conveyance of the recording material, a CPU 242 discriminates that a conveyance jam (conveyance abnormality) occurred in the finisher 109. In this case, the CPU 242 notifies the printing device 107 that the conveyance jam occurred.

### <Fixing Device>

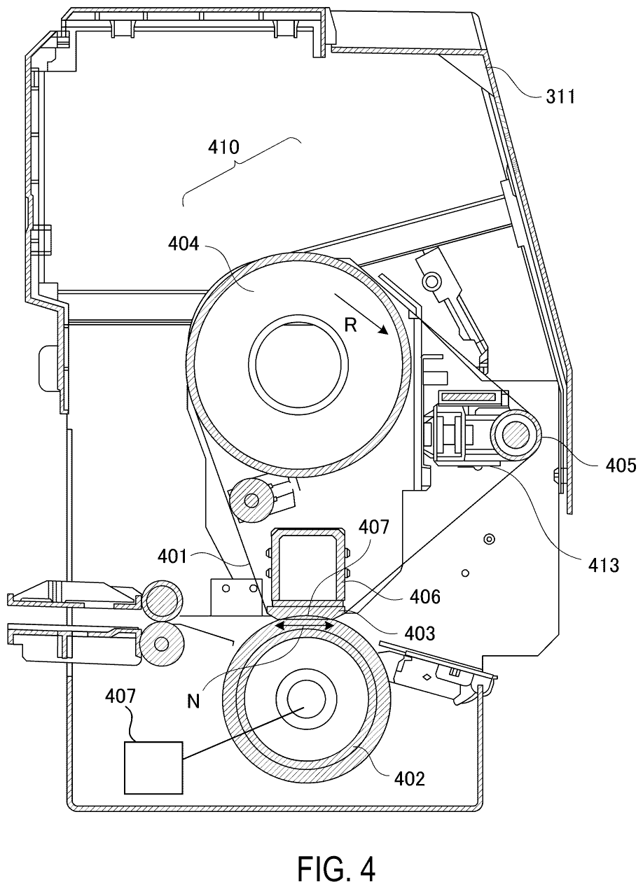

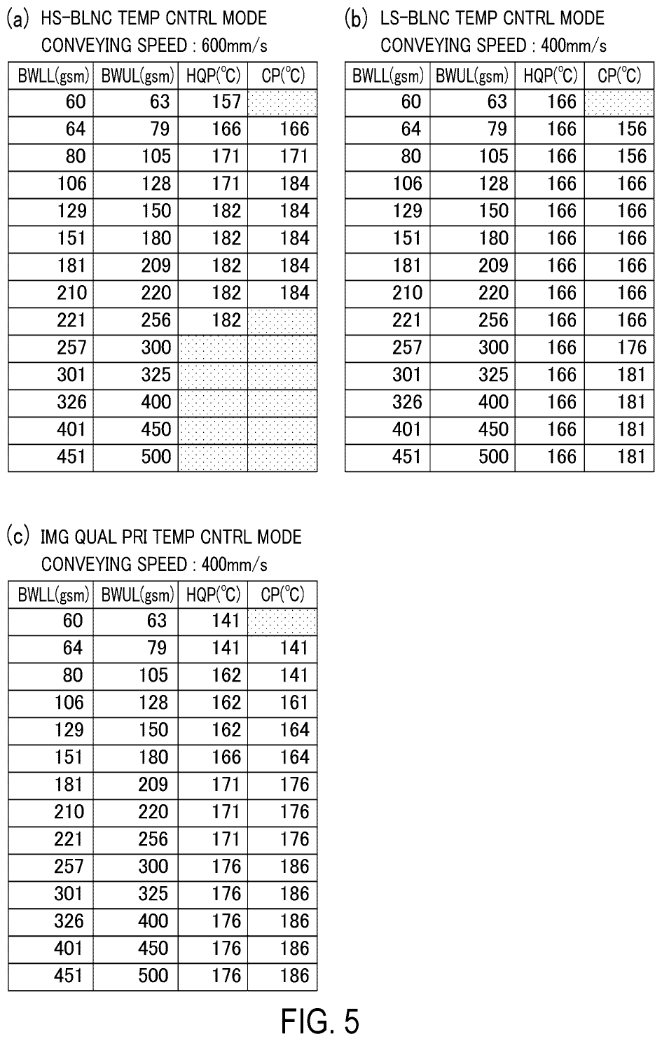

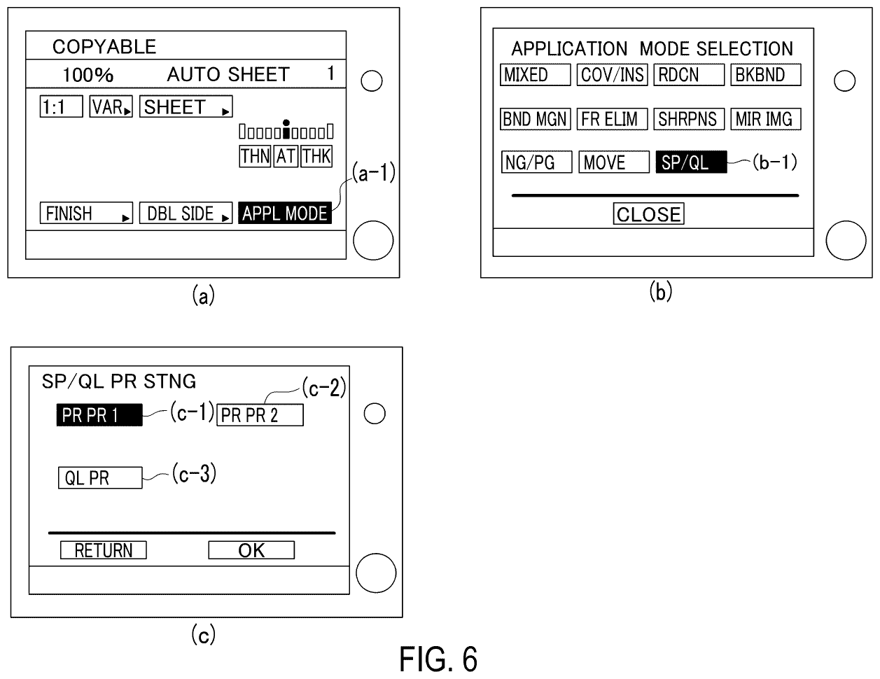

Next, using FIG. 4, details of a constitution of the fixing device 311 in this embodiment will be described. FIG. 4 is a sectional view of the fixing device 311 in this embodiment. In FIG. 4, the recording material is conveyed from a right direction toward a left direction on the drawing sheet. The fixing device 311 includes a heating unit 410 including a heat source and a pressing roller 402 for forming a fixing nip N in cooperation with the heating unit 410. The heating unit 410 includes a fixing belt 401 as a first rotatable member which is endless and rotatable, a pad member (hereinafter, referred to as a pad) 403, a heating roller 404 as a heating portion, and starring roller 405.

The heating roller 404 is provided therein with an unshown halogen heater is capable of generating heat to a predetermined temperature. The fixing belt is heated by the heating roller 404 and is controlled to a fixing temperature depending on a basis weight of the recording material on the basis of a detected temperature by an unshown thermistor. The thermistor may have a form for detecting a surface temperature of the heating roller 404 or may also have a form for detecting a surface temperature of the fixing belt 401. The pressing roller 402 as a second rotatable member is a roller prepared by forming an elastic layer on an outer peripheral surface of a shaft and by forming a parting layer on an outer peripheral surface of the elastic layer. In this embodiment, the pressing roller 402 is rotationally driven by a motor 407 as a driving portion, so that the fixing belt 401 to which the pressing roller 402 is contacted is rotated by the pressing roller 402. When the recording material carrying thereon an unfixed toner image is nipped and conveyed in the fixing nip N by the pressing roller 402 and the fixing belt 401, heat and pressure needed for fixing are imparted to the recording material. Then, the toner image is fixed on the recording material. Incidentally, the motor 407 may only be required to rotate at least one of the fixing belt 401 and the pressing roller 402.

### <Relationship Between Basis Weight and Conveying Speed>

In this embodiment, the image forming apparatus 101 is capable of conveying the recording material at a plurality of speeds (herein, referred to as conveying speeds) including a first speed and a second speed, as a speed when the recording material passes through the fixing device 311. In this embodiment, the first speed is a high conveying speed of “600 mm/s”, and the second speed is a lower conveying speed of “400 mm/s” slower than the first speed. In this embodiment, the two speeds are cited as an example, but the recording material may also be conveyed at three or more speeds.

In this embodiment, the reason why the recording material is conveyed at the plurality of conveying speeds will be described. With a larger basis weight, a heat quantity needed for fixing the toner image becomes higher. With a faster recording material conveying speed, a time in which heat is applied to the recording material in the fixing nip N becomes shorter. For that reason, in the case where recording materials large in basis weight are continuously conveyed to a high speed, a fixing property is not ensured in some instances. Therefore, in order to ensure the fixing property of the recording materials large in basis weight, in addition to the high conveying speed, there is a need to provide the low conveying speed.

### <Temperature Table>

Parts (a) to (c) of FIG. 5 are temperature tables each showing fixing temperatures applicable at the above-described two kinds of the conveying speeds. Part (a) of FIG. 5 is the temperature table showing the fixing temperatures in a high-speed balance temperature-control mode (conveying speed: 600 mm/s), part (b) of FIG. 5 is the temperature table showing the fixing temperatures in a low-speed balance temperature-control mode (conveying speed: 400 mm/s), and part (c) of FIG. 5 is the temperature table showing the fixing temperatures in an image-quality priority temperature control mode (conveying speed: 400 mm/s). These temperature tables are stored in the memory 223 (see FIG. 2) in advance. In each of the temperature tables, the fixing temperatures depending on the basis weights of the recording materials are set for each of the kinds (high-quality paper and coated paper in this embodiment) of the recording materials.

However, as shown in part (a) of FIG. 5, in the temperature table in the high-speed balance temperature-control mode, depending on the kind of the recording material, fixing temperatures depending on recording material basis weights of a predetermined value or more are not set. This is because in the case of the conveying speed of “600 mm/s”, the halogen heater does not have capacity for heating the fixing belt 401 to a fixing temperature needed for imparting a heat quantity, suitable for fixing, to the recording material.

The temperature setting portion 263 (see FIG. 2) is capable of setting, on the basis of the temperature table, the temperature of the fixing belt 401 to a first temperature when the recording material basis weight is a first basis weight and to a second temperature lower than the first temperature when the recording material basis weight is a second basis weight smaller than the first basis weight. The CPU 222 is capable of changing the temperature of the fixing belt 401 on the basis of the set temperature. Incidentally, it takes time until the temperature of the fixing belt 401 becomes the set temperature, and therefore, there is a need to temporarily stop, a mixed job (printing operation of the image forming apparatus under execution, and temporary stop is performed, so that productivity of the recording material lowers. In addition, also, when the conveying speed is changed during execution of the mixed job, there is a need to temperature stop the mixed job under execution, and the temporary stop is performed, so that the productivity of the recording material lowers.

### <Printing Mode>

Next, an operation mode executable in the fixing device 311 in this embodiment will be described using parts (a) to (c) of FIG. 6. The fixing belt 310 is capable of executing a productivity priority mode and an image quality priority mode, and the productivity priority mode is divided into a mixed loading productivity priority mode and a productivity priority mode for each sheet kind. In accordance with a setting screen displayed on the display 225 by the CPU 222, the user is capable of setting the operation mode.

Part (a) of FIG. 6 is an initial screen. When the user selects an “application mode” (a-1), the CPU 222 causes the display 225 to display a selection screen of the application mode shown in part (b) of FIG. 6. When the user selects “speed/image quality” (b-1) which is a soft key from the selection screen of the application mode, the CPU 222 causes the display 225 to display a setting screen of speed/image-quality priority adjustment shown in part (c) of FIG. 6.

In the case where the user sets productivity priority 1(c-1) and presses down “OK”, the fixing device 311 operates in the mixed loading productivity priority mode (first mode). During setting of this mode, whether to use the temperature table of the “high-speed balance temperature-control mode” or the temperature table of the “low-speed balance temperature-control mode” will be described in “job start processing” later.

In the case where the user sets productivity priority 2(c-2) and presses down “OK”, the fixing device 311 operates in the productivity priority mode for each sheet kind. During setting of this mode, the temperature table of the “high-speed balance temperature-control mode” shown in part (a) of FIG. 5 is used for the high-quality paper of 60 gsm or more and 256 gsm or less in basis weight and for the coated paper of 64 gsm or more and 220 gsm or less in basis weight, and the temperature table of the “low-speed balance temperature-control mode” shown part (b) of FIG. 5 is used for the high-quality paper of 257 gsm or more and 500 gsm or less in basis weight and for the coated paper of 221 gsm or more and 500 gsm or less in basis weight.

In the case where the user sets image-quality priority (c-3) and presses down “OK”, the fixing device 311 operates in the image-quality priority mode (second mode). The image-quality priority mode is a mode such that an image quality of the image to be formed is prioritized. For that reason, as shown in the temperature table of the image-quality priority temperature control mode shown in part (c) of FIG. 5, during the operation in the image-quality priority mode, the temperature can be changed depending on the basis weight more finely than during the operation in the productivity priority mode. That is, the image quality of the toner image formed on the recording material depends on the heat quantity imparted to the toner image. There is an optimum temperature for fixing the toner image depending on the basis weight of the recording material, and the image quality of the toner image can be improved by applying the optimum temperature. In the temperature table of the image-quality priority temperature control mode, depending on the basis weight and the kind of the recording material, the fixing temperature is finely defined. For that reason, in the case where in the mixed job, the toner images are printed in the operation in the image-quality priority mode, the number of times of change in temperature of the fixing belt 310 is capable of becoming larger than in the case where in the mixed job, the toner images are printed in the operation in the production priority mode.

### <Job Start Processing>

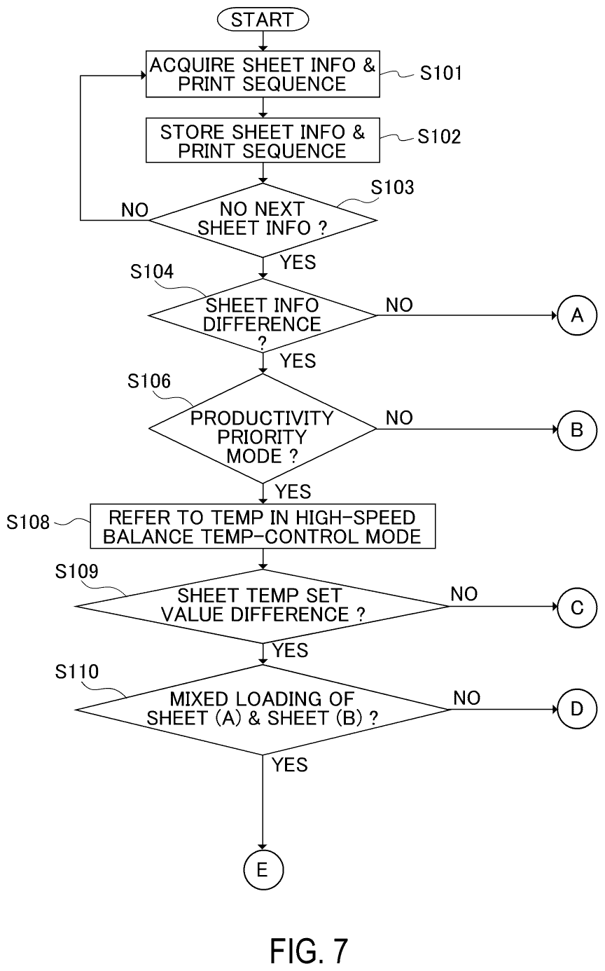

Next, a job start processing in this embodiment will be described using FIG. 7 to part (b) of FIG. 12 while making reference to FIG. 2. FIGS. 7 7 to 10 are flowcharts showing the job start processing.

In this embodiment, for convenience of illustration, a series of job start processes is shown by being divided into four portions. The job start processing is started by that the CPU 222 of the printing device 107 receives, from the operating portion 224 (or the client PC 103), a start instruction of a continuous image forming job such as the mixed job.

As shown in FIG. 7, when the CPU 222 receives the start instruction of the continuous image forming job, the CPU 222 acquires recording material information sequentially from a first sheet through an acquiring portion 261, and acquires a printing sequence (order) in accordance with the acquired recording material information (S101). The recording material information capable of being acquired by the acquiring portion 261 includes information on the recording material basis weight. The CPU 222 causes the memory 223 to store the acquired recording material information and the acquired printing sequence (S102). The CPU 222 repeats the acquisition of the recording material information and the printing sequence (S101) and the storage of the recording material information and the printing sequence (S102) until the recording material information cannot be acquired (S103).

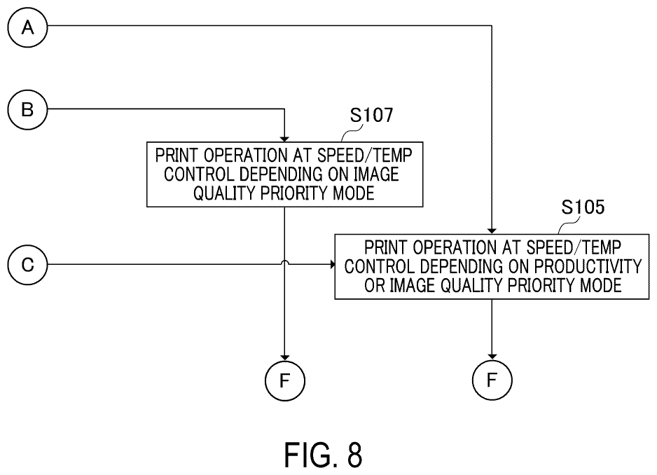

The CPU 222 discriminates whether or not the received continuous image forming job is the mixed job different in recording material information (basis weight) (S104). In the case where there is no difference in recording material basis weight, i.e., in the case where the continuous image forming job is not the mixed job (NO of S104), as shown in FIG. 8, the CPU 222 sets a conveying speed and a temperature by making reference to the temperature table (FIG. 5), on the basis of first recording material information, for either one of the productivity priority mode and the image-quality priority mode which have already been inputted, and then starts the printing operation (S105).

In the case where there is a difference in recording material information, i.e., in the case where the continuous image forming job is the mixed job (YES of S104), the CPU 222 discriminates whether the inputted operation mode is the productivity priority mode or the image-quality priority mode (S106).

In the case where the image-quality mode is inputted (NO of S106), as shown in FIG. 8, the CPU 222 makes reference to the temperature table (part (c) of FIG. 5) of the image-quality priority mode, and sets the conveying speed and the temperature on the basis of the first recording material information, and then starts the printing operation (S107).

In the case where the productivity priority mode is inputted (YES of S106), the CPU 222 makes reference to the temperature table (part (a) of FIG. 5), and makes reference to a temperature set value for each recording material (S108). Then, the CPU 222 discriminates whether or not the temperature set value referred to is different for each recording material (S109). In the case where the temperature set value is not different (NO of S109), the CPU 222 makes reference to the temperature table (part (a) of FIG. 5) of the high-speed balance temperature-control mode and sets the conveying speed and the temperature on the basis of the first recording material information, and then starts the printing operation (S105). However, in the case where the recording materials are only recording materials (A) of a kind for which a temperature set value is not shown in the temperature table (part (a) of FIG. 5) of the high-speed balance temperature-control mode, the CPU 222 makes reference to the temperature table (part (b) of FIG. 5) of the low-speed balance temperature-control mode and sets the conveying speed and the temperature on the basis of the first recording material information, and then starts the printing operation.

In the case where the temperature set value is different (YES of S109), in the temperature table (part (a) of FIG. 5) of the high-speed balance temperature-control mode referred to, the CPU 222 discriminates whether or not both the recording material (A) of the kind for which the temperature set value depending on the recording material information is not shown and a recording material (B) of the kind for which the temperature set value depending on the recording material information is shown are present (S110).

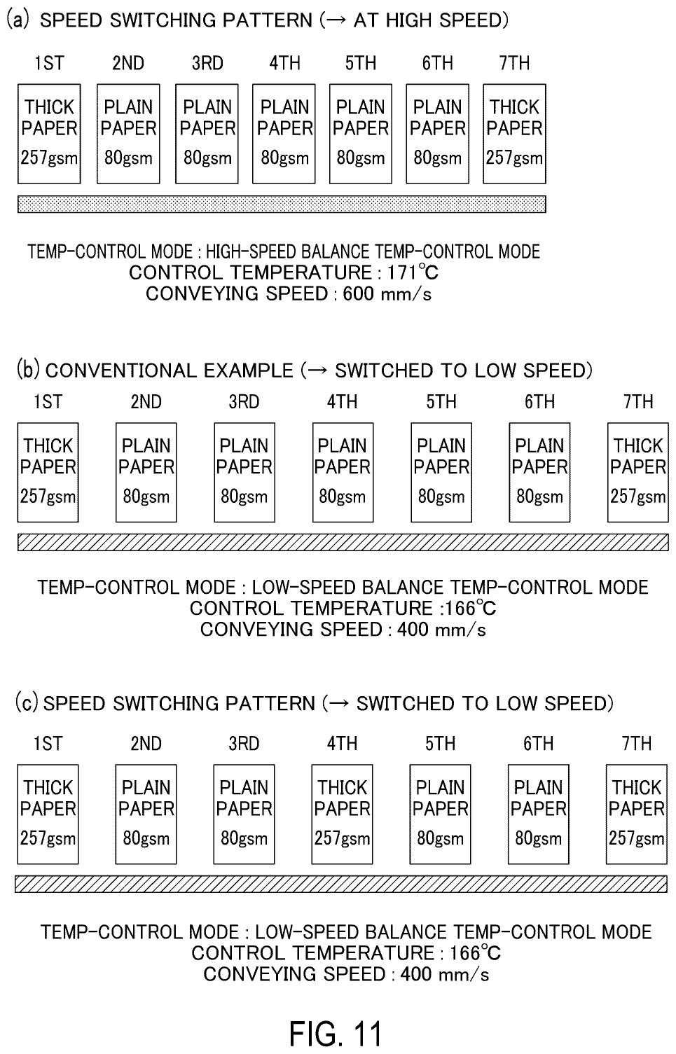

In the case where both the recording material (A) and the recording material (B) are present (YES of S110), as shown in FIG. 10, the CPU 222 makes reference to the printing sequence, and discriminates whether or not there is no portion where the or more recording materials (A) as a first recording material are continuous (recording materials (A) are continuous in a first number of sheets or more) (S111). In the case where there is the portion where the two or more recording materials (A) are continuous (NO of S111), the CPU 222 makes reference to the temperature table (part (b) of FIG. 5) of the low-speed balance temperature-control mode and sets the conveying speed and the temperature on the basis of the recording material information of the recording material (A), and then starts the printing operation (S112).

In the case where there is no portion where the two or more recording materials (A) and continuous (YES of S111), the CPU 222 discriminates whether or not there if a portion where five or more recording materials (B) as a second recording material are continuous (recording material is (B) are continuous in a second number of sheets or more) after the recording material(s) (A) (S113). In the case where there is no portion where the five or more recording materials (B) are continuous (NO of S113), the CPU 222 makes reference to the temperature table (part (b) of FIG. 5) of the low-speed balance temperature-control mode, and sets the conveying speed and the temperature on the basis of the recording material information of the recording material (A), and then starts the printing operation (S112). In the case where there is the portion where the five or more recording materials (B) are continuous (YES of S113), the CPU 222 makes reference to the temperature table (part (a) of FIG. 5) of the high-speed balance temperature-control mode, and sets the conveying speed and the temperature on the basis of the recording material information of the recording material (B), and then starts the printing operation (S114).

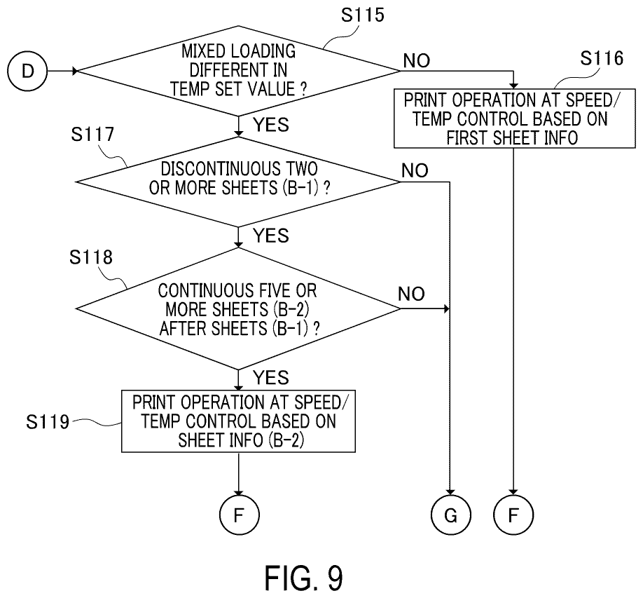

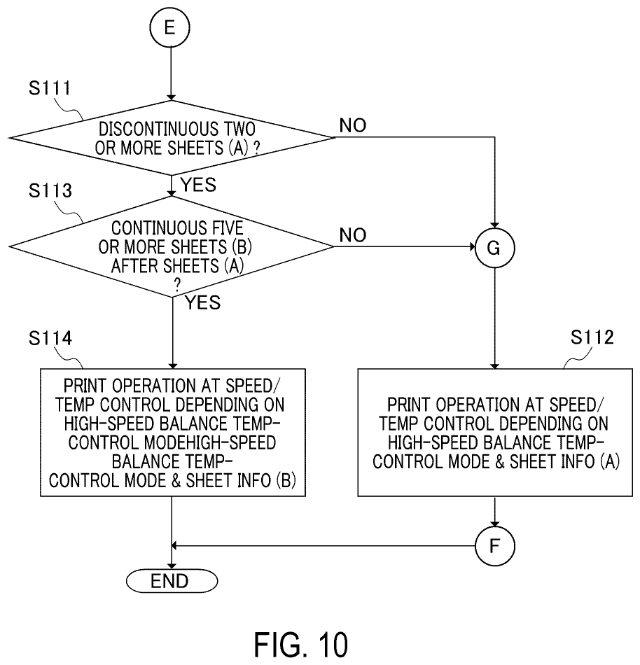

In the case where only the recording materials (B) of the kind for which the temperature set values are shown are present (NO of S110), as shown in FIG. 9, the CPU 222 makes reference to the temperature set value depending on the recording material information of the recording material (B), and discriminates whether or not the temperature set value is different (S115). In the case where the temperature set value is the same, i.e., in the case where the job is not the mixed job (NO of S115), the CPU 222 sets the conveying speed and the temperature on the basis of the first recording material information and then starts the printing operation (S116). On the other hand, in the case where the temperature set value is different, i.e., in the case where the job is the mixed job (YES of S115), the CPU 222 makes reference to the printing sequence of recording materials (B-1) high in temperature set value and recording materials (B-2) lower in temperature set value than the recording materials (B-1), and then discriminates whether or not there is a portion where two or more recording materials (B-1) as a first recording material (S117).

In the case where there is the portion where the two or more recording materials (B-1) are continuous (NO of S117), the CPU 222 makes reference to the temperature table (part (b) of FIG. 5) of the low-speed balance temperature-control mode and sets the conveying speed and the temperature on the basis of the recording material information of the recording material (B-1), and then starts the printing operation (S112). In the case where there is no portion where the two or more recording materials (B-1) are continuous (YES of S117), the CPU 222 discriminates whether or not there is a portion where five or more recording materials (B-2) as a second recording material are continuous after the recording material (B-1) (S118).

In the case where there is no portion where the five or more recording materials (B-2) are continuous (NO of S118), the CPU 222 makes reference to the temperature table (part (b) of FIG. 5) of the low-speed balance temperature-control mode and sets the conveying speed and the temperature on the basis of the recording material information of thick paper of 257 gsm, and then starts the printing operation (S112). In the case where there is the portion where the five or more recording materials (B-2) are continuous (YES of S118), the CPU 222 makes reference to the temperature table (part (b) of FIG. 5) of the low-speed balance temperature-control mode and sets the conveying speed and the temperature on the basis of the recording material information of the recording material (B-2), and then starts the printing operation (S119).

Part (a) of FIG. 11 is a schematic view showing a specific example for illustrating the processes S110, S111, S113, and S114. Part (b) of FIG. 11 is a schematic view showing a specific example for illustrating a conventional example. As shown in part (a) of FIG. 11 and part (b) of FIG. 11, in the case of a mixed job in which a first sheet is the thick paper of 257 gsm, second to sixth sheets are plain paper of 80 gsm, and a seventh sheet is the thick paper of 257 gsm, in the temperature table of the high-speed balance temperature-control mode shown in part (a) of FIG. 5, the temperature set value for the thick paper of 257 gsm is not defined. For that reason, in the conventional example, as shown in part (b) of FIG. 11, in the case where the mixed job in which the thick paper of 257 gsm and the plain paper of 80 gsm are present in mixture, there is a need to use the temperature table (part (b) of FIG. 5) of the low-speed balance temperature-control mode.

Therefore, by executing the job start processing in this embodiment, after the image is printed on the first thick paper of 257 gsm at the conveying speed (600 mm/s) and the temperature (171° C.) which are set for the plain paper of 80 gsm, the images are subsequently printed on from the second plain paper of 80 gsm to the sixth plain paper of 80 gsm, so that heat taken by sheet passing of the first sheet (thick paper) is restored. By this, the image on the seventh thick paper of 257 gsm is kept fixable in the setting of the conveying speed (600 mm/s) and the temperature (171° C.), and therefore, the CPU 222 starts the printing operation with use of the temperature table (part (a) of FIG. 5) of the high-speed balance temperature-control mode.

Part (c) of FIG. 11 is a schematic view showing a specific example for illustrating the processes S110, S111, S113, and S112 of the job. In the case of the mixed job in which the first sheet, the fourth sheet, and the seventh sheet are the thick paper of 257 gsm, and in which the second sheet, the third sheet, the fifth sheet, and the sixth sheet are the plain paper of 80 gsm, when the image is printed on the first thick paper of 257 gsm at the conveying speed (600 mm/s) and the temperature (171° C.) which are set for the plain paper of 80 gsm, there is a liability that during printing of the image on the fourth thick paper of 257 gsm, the temperature of the fixing device is not in a state in which a fixing property is ensured, and thus improper fixing occurs. For that reason, setting of the conveying speed and the temperature is made using the temperature table (part (b) of FIG. 5) of the low-speed balance temperature-control mode, and then printing operation is started.

Part (a) of FIG. 12 is a schematic view showing a specific example for illustrating the processes S110, S115, S117, S118, and S119 of the job start processing. In the case of the mixed job in which the first sheet is the thick paper of 181 gsm, the second to the sixth sheet are the plain paper of 80 gsm, and the seventh sheet is the thick paper of 181 gsm, on the basis of the temperature table of the high-speed balance temperature-control mode shown in part (a) of FIG. 5, the temperature set value of the thick paper of 181 gsm is “182° C.” (first temperature), and the temperature set value of the plain paper of 80 gsm is “171° C.” (second temperature). In this case, the image is printed on the first thick paper of 181 gsm at the conveying speed (600 mm/s) and the temperature (171° C.), and thereafter, the images are printed on from the second plain paper of 80 gsm to the sixth plain paper of 80 gsm, so that the image is fixable on the seventh thick paper of 181 gsm while keeping the setting of the conveying speed (600 mm/s) and the temperature (171° C.), and therefore, the printing operation is started using the temperature table (part (a) of FIG. 5) of the high-speed balance temperature-control mode.

Part (b) of FIG. 12 is a schematic view showing a specific example for illustrating the processes S110, S115, S117, and S112 of the job start processing. In the case of the mixed job in which the first sheet, the second sheet, and the seventh sheet are the thick paper of 181 gsm, and in which the third sheet, the fourth sheet, the fifth sheet, and the sixth sheet are the plain paper of 80 gsm, when the image is printed on the first thick paper of 181 gsm at the conveying speed (600 mm/s) and the temperature (171° C.) which are set for the third plain paper of 80 gsm, there is a liability that during printing of the image on the second thick paper of 181 gsm, the temperature of the fixing device is not in a state in which the fixing property can be ensured, and thus fixing failure occurs. Further, when the image is printed at the conveying speed (600 mm/s) and the temperature (171° C.) which are set for the first plain paper of 80 gsm, there is a liability that during printing of the image on the third thick paper of 181 gsm, conveyance failure occurs. For this reason, the printing operation is started using the temperature table (part (b) of FIG. 5) of the low-speed balance temperature-control mode.

Thus, in this embodiment, when the productivity priority mode is inputted, in the case where the mixed job in which two sheets or more of the thick paper of 257 gsm or 181 gsm are not continuous and in which five sheets or more of the plain paper of 80 gsm are continuous after the thick paper of 257 gsm or 181 gsm is acquired, execution of the printing operation is started in the setting such that the conveying speed is set at the conveying speed (600 mm/s) of the high-speed balance temperature-control mode and that the fixing temperature is set at the temperature (second temperature, 171° C.). Further, when the production priority mode is inputted, in the case where the mixed job in which the two sheets or more of the thick paper of 257 gsm or 181 gsm are continuous or in the case where the five sheets or more of the plain paper of 80 gsm are not continuous after the thick paper of 257 gsm or 181 gsm, the conveying speed is set at the conveying speed (400 mm/s) of the low-speed balance temperature-control mode and the fixing temperature is set at a temperature (third temperature, 166° C.) of the plain paper of 80 gsm, and then execution of the mixed job is started.

As described above, in this embodiment, before the mixed job in which the toner images are continuously formed on the plurality of recording materials different in fixing temperature is started, depending on a printing sequence of these recording materials, the conveying speed is set at a faster conveying speed and in addition, the fixing temperature is set at a fixing temperature capable of ensuring the toner image fixing property even at the faster conveying speed, and then the mixed job is started. By this, the number of times of switching of the fixing temperature and the conveying speed is decreased without causing the toner image fixing failure, so that it is possible to suppress a lowering in productivity of the recording material.

### Second Embodiment

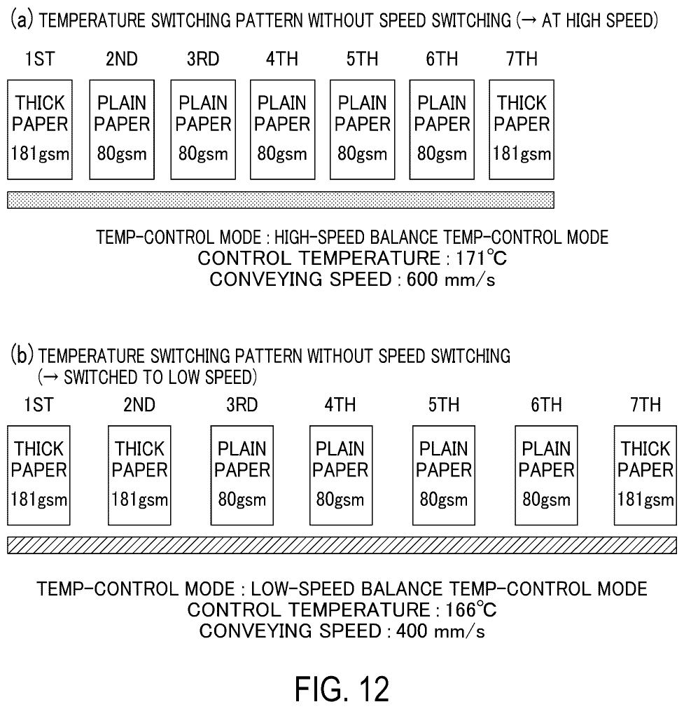

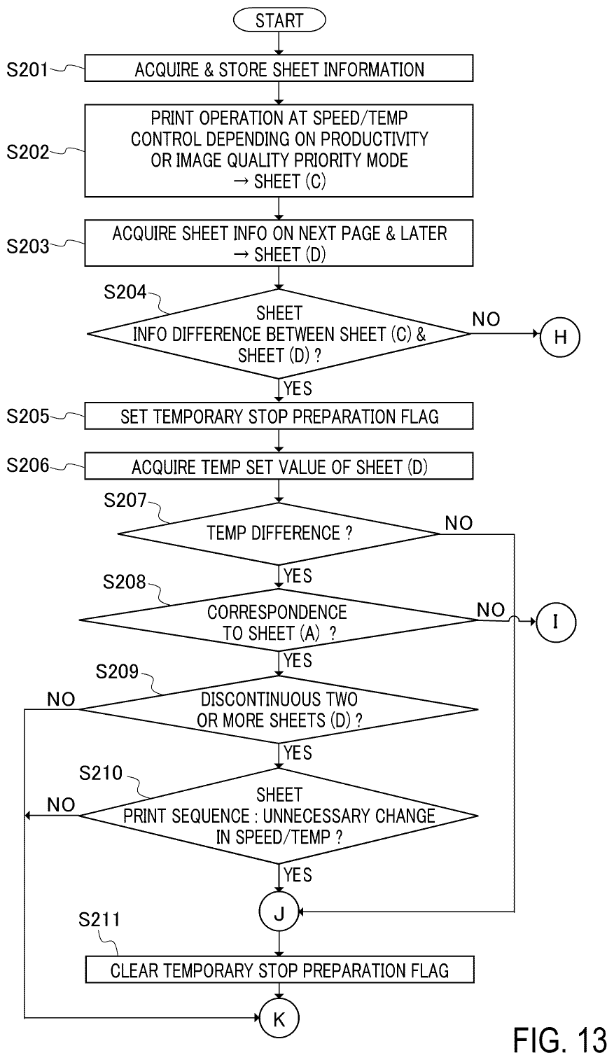

In the above-described first embodiment, the mixed job is executed in accordance with the conveying speed and the fixing temperature which are set before the mixed job is started, so that the number of times of switching of the fixing temperature and the conveying speed is decreased, and thus the lowering in productivity of the recording material is suppressed, but the present disclosure is not limited thereto. For example, during execution of the mixed job, the switching of the fixing temperature and the conveying speed is not performed depending on the printing sequence of images on the recording materials, so that the lowering in productivity of the recording material due to temporary stop of the job with the switching of the fixing temperature and the conveying speed may be suppressed. In the following, a second embodiment for realizing such a constitution will be described using FIGS. 13 to 15 while making reference to FIG. 2. FIGS. 13 to 15 are flowcharts each showing temporary stop processing during execution of the job. In this embodiment, for convenience of illustration, a series of temporary stop processes was described by being divided into three portions.

As shown in FIG. 13, when the CPU 222 receives a start instruction of a continuous image forming job, the CPU 222 acquires recording material information of the job sequentially from a first sheet through the acquiring portion 261 and acquires a printing sequence in accordance with the acquired recording material information, and then causes the memory 223 to store the acquired recording material information and the acquired printing sequence (S201). Here, the acquired recording material information includes information on the basis weight of the recording material. The CPU 222 repeats acquisition and storage of the recording material information and the printing sequence until the recording material information cannot be obtained.

On the basis of the recording material information (basis weight), the CPU 222 sets the conveying speed and the temperature by making reference to the temperature table (FIG. 5) of either one of the productivity priority mode and the image quality priority mode which have already been inputted, and then starts a printing operation (S202). Thereafter, a recording material during the printing operation is referred to as a recording material (C). The CPU 222 acquires, from the memory 223, recording material information on a recording material as a next page subsequent to the recording material (C) during the printing operation (S203). Thereafter, the recording material as the next page is referred to as a recording material (D).

The CPU 222 discriminates whether or not there is a difference between the recording material information on the recording material (C) during the printing operation and the recording material information on the recording material (D) as the next page (S204). In the case where there is no difference in recording material information (NO of S204), the CPU 222 continues the printing operation while keeping the present setting of the conveying speed and the temperature (S221).

In the case where there is the difference in recording material information (YES of S204), the CPU sets a temporary stop preparation flag (S205). Then, the CPU 222 makes reference to the temperature table (FIG. 5) of either one of the productivity priority mode and the image quality priority mode which have already been inputted, and then acquires a temperature set value of the recording material (D) (S206). The CPU 222 discriminates whether or not the acquired temperature set value is different from the temperature set value of the recording material (C) during the printing operation (S207). In the case where the temperature set value is not different from the temperature set value of the recording material (C) during the printing operation (NO of S207), the CPU 222 jumps to a process S211 and clears the temporary stop preparation flag. On the other hand, in the case where the temperature set value of the recording material (D) is different from the temperature set value of the recording material (C) during the printing operation (YES of S207), the CPU 222 discriminates whether or not the recording material (D) is the recording material (A) of the kind for which the temperature set value is not shown in the temperature table (part (a) of FIG. 5) of the high-speed balance temperature-control mode (S208).

In the case where the recording material (D) corresponds to the recording material (A) (YES of S208), the CPU 222 discriminates whether or not there is no portion where two sheets or more of the recording materials (D) are continuous by making reference to the printing sequence stored in S203 (S209). In the case where there is the portion where the two sheets or more of the recording materials (D) are continuous (the recording materials (D) are continuous in a first number or more) (NO of S209), the CPU 222 jumps to a process S212.

In the case where there is no portion where the two sheets or more of the recording materials (D) are continuous (YES of S209), the CPU 222 makes reference to the printing sequence and discriminates whether or not the recording material (D) corresponding to the recording material (A) is subsequent to the continuous five sheets or more (a second number or more) of the recording materials (C) as a second recording material during the printing operation (S210). In the case where the recording material (D) is subsequent to the five sheets or more or the recording materials (C) (YES of S210), the CPU discriminates that the printing sequence is a printing sequence of recording materials for which a change is speed/temperature is unnecessary, and thus discriminates that operation continuation is possible, so that the CPU 222 clears the temporary stop preparation flag (S211). In the case where the recording material (D) is subsequent to the recording materials (C) in a number less than the five sheets (NO of S210), the CPU 222 discriminates that the printing sequence is a printing sequence of the recording materials for which the change in speed/temperature is necessary, and then jumps to the process S212 without clearing the temporary stop preparation flag.

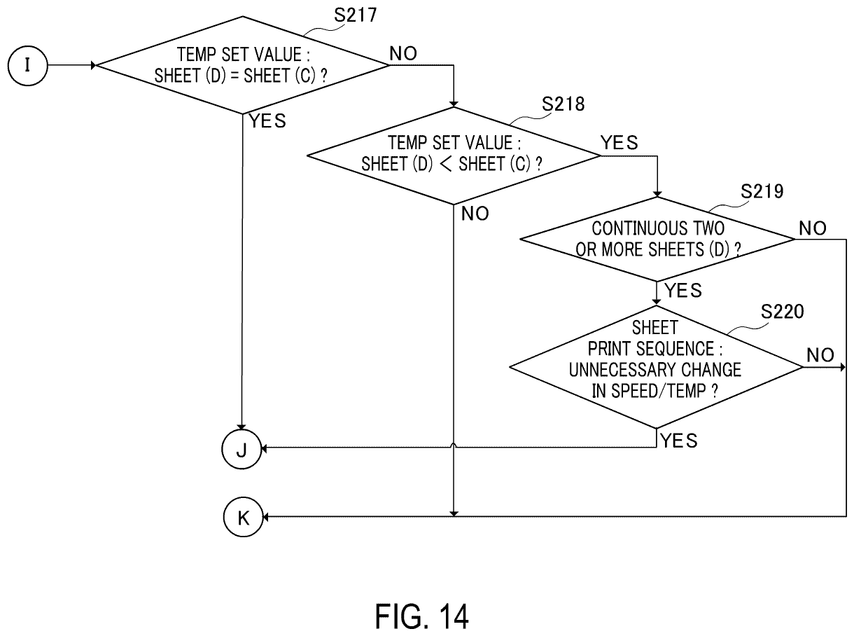

In the case where the recording material (D) does not correspond to the recording material (A), i.e., corresponds to the recording material (A) (NO of S208), as shown in FIG. 14, the CPU 222 discriminates whether or not the temperature set value of the recording material (D) and the temperature set value of the recording material (C) are the same (S217). In the case where the temperature set value of the recording materials (D) and (C) are the same (YES of S217), the CPU 222 discriminates that operation continuation is possible without changing the present setting, and clears the temporary stop preparation flag (S211). In the case where the temperature set values of the recording materials (D) and (C) are not the same (NO of S217), the CPU 222 discriminates whether or not the temperature set value of the recording material (D) is lower than the temperature set value of the recording material (C) (S218). In the case where the temperature set value of the recording material (D) is not lower than the temperature set value of the recording material (C) (NO of S218), the CPU 222 jumps to the process S212.

In the case where the temperature set value of the recording material (D) is lower than the temperature set value of the recording material (C) (YES of S218), the CPU 222 discriminates whether or not there is a portion where two sheets or more of the recording materials (D) corresponding to the recording materials (B) are continuous by making reference to the printing sequence (S219). In the case where there is no portion where the two sheets or more of the recording materials (D) are continuous (NO of S219), the CPU 222 jumps to the process S212. On the other hand, in the case where there is the portion where the two sheets or more of the recording materials (D) are continuous (YES of S219), the CPU 222 discriminates whether or not the recording material (D) is subsequent to five sheets or more of the recording materials (C) during the printing operation by making reference to the printing sequence (S220). In the case where the recording material (D) is subsequent to the five sheets or more of the members (C) (YES of S220), the CPU 222 discriminates that the printing sequence is a printing sequence in which a change in speed/temperature is unnecessary and thus discriminates that operation continuation is possible without changing the present setting, and then clears the temporary stop preparation flag (S211). In the case where the recording material (D) is subsequent to the recording materials (C) in a number less than five sheets (NO of S220), the CPU 222 discriminates that the printing sequence is a printing sequence in which the change in speed/temperature is necessary, and then jumps to the process S212 without clearing the temporary stop preparation flap.

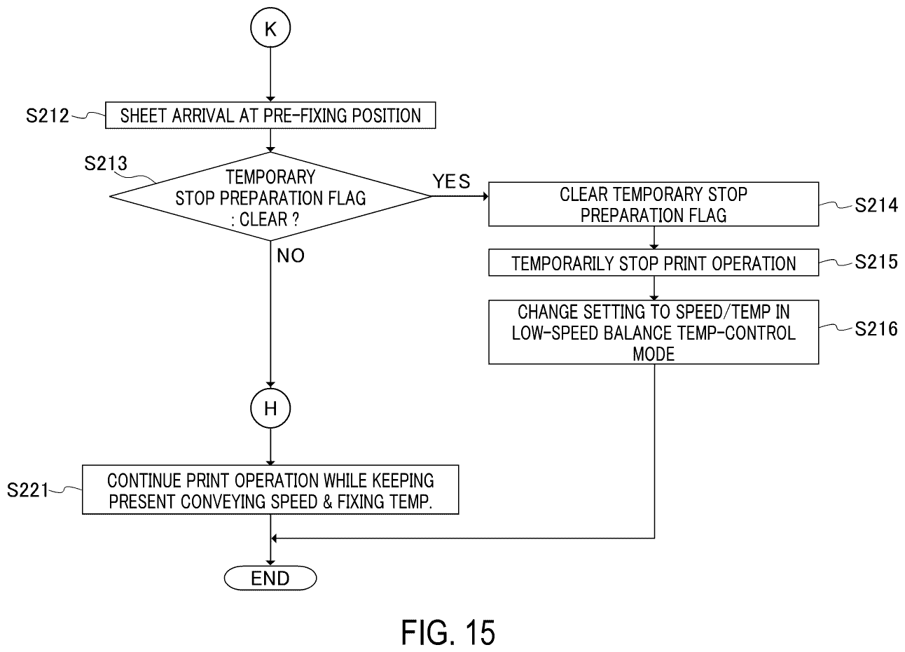

As shown in FIG. 15, at a timing when the recording material (C) during the printing operation reaches a pre-fixing position detected by the recording material detecting sensor 320 (S212), the CPU 222 discriminates whether or not temporary stop of the printing operation is needed by making reference to the temporary stop preparation flag (S213). In the case where the temporary stop preparation flag is cleaned (YES of S213), the CPU 222 does not stop conveyance of the recording materials and continues the printing operation without changing the present conveying speed and the present temperature (S221). In the case where the temporary stop preparation flag is set (NO of S213), the CPU 222 stops the conveyance of the recording materials and temporarily stops the printing operation in order to makes the change in speed/temperature (S215). Thereafter, on the basis of the recording material information of the recording material (D) subsequent in printing sequence to the recording material (C) during the printing operation, the CPU 222 changes the conveying speed and the temperature by making reference to the temperature table (part (b) of FIG. 5) of the low-speed balance temperature-control mode, and then resumes the printing operation (S216).

Thus, in this embodiment, in the case where the mixed job satisfies, for example, a condition in which two sheets or more of the thick paper of 257 gsm or 181 gsm are not continuous and in which five sheets or more of the plain paper of 80 gsm are continuous after the thick paper of 257 gsm or 181 gsm, during execution of the mixed job using the thick paper and the plain paper as the recording materials, when the fixing operation in which images are fixed on one of the thick paper and the plain paper and then are continuously fixed on the other paper is executed, conveyance of the recording materials is not stopped and the fixing operation of the image on the other paper (recording material) without changing the fixing temperature and the conveying speed depending on the one paper (recording material). In the case where the mixed job does not satisfy the above-described condition, during the execution of the mixed job, when the fixing operation in which the images are fixed on one of the thick paper and the plain paper and then are continuously fixed on the other paper is executed, conveyance of the recording materials is stopped, and the fixing temperature is changed from a fixing temperature depending on one recording material to a fixing temperature depending on the other recording material and then the fixing operation of the image on the other recording material is performed. Or, the conveying speed is changed from a conveying speed depending on one recording material to a conveying speed depending on the other recording material, and then the fixing operation of the image on the other recording material is performed.

As described above, in this embodiment, during execution of the mixed job in which the toner images are continuously formed on the plurality of recording materials different in fixing temperature, depending on a printing sequence of these recording materials, conveyance of the recording materials is not stopped, and the mixed job is continued without changing the fixing temperature and the conveying speed. By this, the number of times of switching of the fixing temperature and the conveying speed is decreased without causing the toner image fixing failure, so that it is possible to suppress a lowering in productivity of the recording material.

### Other Embodiments

Incidentally, in the above-described first and second embodiments, as the condition of the printing sequence of the images on the recording materials, for example, the condition in which “two sheets or more” of the thick paper are not continuous and in which “five sheets or more” of the plain paper are continuous after the thick paper is cited, but the present disclosure is not limited thereto. The above-described number of sheets of the recording materials such as “two sheets or more” or “five sheets or more” may be changeable on the basis of a detection result of the temperature/humidity sensor 252. For example, when the temperature and the humidity detected by the temperature/humidity sensor 252 are not less than predetermined values (for example, 20° C., 60% RH), the number of sheets may be set to “two sheets or more” and “five sheets or more”, and when the temperature and the humidity are less than the predetermined values, the number of sheets may be set to “three sheets or more” and “eight sheets or more”.

According to the present disclosure, in the mixed job in which the recording materials different in fixing temperature are present in mixture, the number of times of switching of the fixing temperature and the conveying speed is decreased, so that it is possible to suppress a lowering in productivity of the recording material.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-120346, filed on Jul. 25, 2024, which is hereby incorporated by reference herein in its entirety.

What is claimed is:

1. An image forming apparatus comprising:
an image forming unit configured to form a toner image on a recording material;
a fixing unit including a first rotatable member, a second rotatable member configured to form a fixing nip, in contact with the first rotatable member, in which the recording material is nipped and conveyed therebetween, a driving portion configured to rotate at least either one of the first rotatable member and the second rotatable member, and a heating portion configured to heat the first rotatable member, the fixing unit being configured to fix the toner image on the recording material under application of heat and pressure to the recording material on which the toner image is formed;
an input portion capable of inputting either one of operation modes including a first mode in which a conveying speed at which the recording material is conveyed in the fixing nip is a first speed and a second mode in which the conveying speed is a second speed slower than the first speed;
a temperature setting portion capable of setting a fixing temperature, which is a set temperature of the first rotatable member, to a first temperature in a case where a basis weight of the recording material is a first basis weight, and capable of setting the fixing temperature to a second temperature lower than the first temperature in a case where the basis weight is a second basis weight smaller than the first basis weight;
an acquiring portion capable of acquiring information on basis weights of a plurality of recording materials; and
a controller capable of controlling the heating portion and the driving portion on the basis of the information on the basis weights acquired by the acquiring portion,
wherein when the first mode is inputted to the input portion when the controller executes a continuous image forming job in which first recording materials each having the first basis weight and second recording materials each having the second basis weight are present in mixture,
in a case where the continuous image forming job is a job in which the first recording materials are not continuous in a first number of sheets or more and in which the second recording materials are continuous in a second number of sheets or more after the first recording material,
the controller executes the continuous image forming job in a setting such that the conveying speed is the first speed and the fixing temperature is the second temperature.

2. An image forming apparatus according to claim 1, wherein when the first mode is inputted to the input portion when the controller executes the continuous image forming job,
in a case where the continuous image forming job is such that the first recording materials are continuous in the first number of sheets, or
in a case where the first recording materials are not continuous in the first number of sheets or more and where the second recording materials are not continuous in the second number of sheets or more after the first recording material,
the controller executes the continuous image forming job in a setting such that the conveying speed is the second speed and the fixing temperature is a third temperature lower than the second temperature.

3. An image forming apparatus according to claim 1, further comprising a detecting portion configured to detect a temperature and a humidity in the image forming apparatus,
wherein the controller is capable of changing the first number of sheets and the second number of sheets on the basis of a detection result of the detecting portion.

4. An image forming apparatus according to claim 2, further comprising a detecting portion configured to detect a temperature and a humidity in the image forming apparatus,
wherein the controller is capable of changing the first number of sheets and the second number of sheets on the basis of a detection result of the detecting portion.

5. An image forming apparatus comprising:
an image forming unit configured to form a toner image on a recording material;
a fixing unit including a first rotatable member, a second rotatable member configured to form a fixing nip, in contact with the first rotatable member, in which the recording material is nipped and conveyed therebetween, a driving portion configured to rotate at least either one of the first rotatable member and the second rotatable member, and a heating portion configured to heat the first rotatable member, the fixing unit being configured to execute a fixing operation for fixing the toner image on the recording material under application of heat and pressure to the recording material on which the toner image is formed;
an acquiring portion capable of acquiring information on basis weights of a plurality of recording materials; and
a controller capable of controlling, on the basis of the information on the basis weights acquired by the acquiring portion, the heating portion so as to be capable of changing a fixing temperature which is a set temperature of the first rotatable member and the driving portion so as to be capable of changing a conveying speed at which the recording material is conveyed in the fixing nip,
wherein in a case where a continuous image forming job in which first recording materials each having a first basis weight and second recording materials each having a second basis weight are present in mixture satisfies a condition in which the first recording materials are not continuous in a first number of sheets or more and in which the second recording materials are continuous in a second number of sheets or more after the first recording material, the controller performs the fixing operation of the first recording material without changing the fixing temperature and the conveying speed depending on the second recording material during execution of the continuous image forming job, and
in a case where the continuous image forming job does not satisfy the condition, the controller performs the fixing operation of the second recording material after the fixing temperature is changed from the fixing temperature depending on the first recording material to the fixing temperature depending on the second recording material.

6. An image forming apparatus comprising:
an image forming unit configured to form a toner image on a recording material;
a fixing unit including a first rotatable member, a second rotatable member configured to form a fixing nip, in contact with the first rotatable member, in which the recording material is nipped and conveyed therebetween, a driving portion configured to rotate at least either one of the first rotatable member and the second rotatable member, and a heating portion configured to heat the first rotatable member, the fixing unit being configured to execute a fixing operation for fixing the toner image on the recording material under application of heat and pressure to the recording material on which the toner image is formed;
an acquiring portion capable of acquiring information on basis weights of a plurality of recording materials; and
a controller capable of controlling, on the basis of the information on the basis weights acquired by the acquiring portion, the heating portion so as to be capable of changing a fixing temperature which is a set temperature of the first rotatable member and the driving portion so as to be capable of changing a conveying speed at which the recording material is conveyed in the fixing nip,
wherein in a case where a continuous image forming job in which first recording materials each having a first basis weight and second recording materials each having a second basis weight are present in mixture satisfies a condition in which the first recording materials are not continuous in a first number of sheets or more and in which the second recording materials are continuous in a second number of sheets or more after the first recording material, the controller performs the fixing operation of the first recording material without changing the fixing temperature and the conveying speed depending on the second recording material during execution of the continuous image forming job, and
in a case where the continuous image forming job does not satisfy the condition, the controller performs the fixing operation of the second recording material after the conveying speed is changed from the conveying speed depending on the first recording material to the conveying speed depending on the second recording material.

7. An image forming apparatus according to claim 5, further comprising a detecting portion configured to detect a temperature and a humidity in the image forming apparatus,
wherein the controller is capable of changing the first number of sheets and the second number of sheets on the basis of a detection result of the detecting portion.

8. An image forming apparatus according to claim 6, further comprising a detecting portion configured to detect a temperature and a humidity in the image forming apparatus,
wherein the controller is capable of changing the first number of sheets and the second number of sheets on the basis of a detection result of the detecting portion.
